(19) United States
(12) Patent Application Publication
(10) Pub. No.: US 2017/0139048 A1
(43) Pub. Date: May 18, 2017

(54) LOADING OF EPHEMERIS DATA INTO A DRONE

(71) Applicant: PARROT DRONES, Paris (FR)

(72) Inventor: Francois Muller, Chelles (FR)

(21) Appl. No.: 15/345,216

(22) Filed: Nov. 7, 2016

(30) Foreign Application Priority Data
Nov. 13, 2015 (FR) 1560859

(51) Int. Cl. G01S 19/08; G05D 1/00; G05D 1/08

(52) U.S. Cl. CPC G01S 19/08; G05D 1/0808; G05D 1/0022; H04W 4/008

(57) ABSTRACT

The invention relates to a method, implemented in a drone piloting device (16), of loading satellite ephemeris data, the drone (10) comprising a geolocation module, the method comprising a step of establishing a communication between the piloting device (16) and the drone (10) according to a given communication mode. The method further comprises the following steps implemented in the piloting device: loading ephemeris data (E26) from a remote server (32) connected to a communication network (30), and sending the loaded ephemeris data (E25) to said drone. The invention has also for object a method of loading satellite ephemeris data, implemented in a drone, for updating ephemeris data of a geolocation module.

The invention relates to the motorized flying machines such as drones, in particular the rotary-wing drones of the quadricopter type or drones of the sailwing type.

The AR.Drone 2.0 or the Bebop Drone of Parrot SA, Paris, France, are rotary-wing drones of the quadricopter type and the eBee of SenseFly SA,

Swiss, is a drone of the sailwing type. They are equipped with a series of sensors (accelerometers, 3-axis gyrometers, altimeter) and may include at least one camera. These drones are provided with several rotors driven by respective motors, adapted to be controlled in a differentiated manner so as to pilot the drone in attitude and speed. These drones may comprise a front video camera capturing an image of the scene towards which the drone is directed.

The front video camera can be used for an “immersive mode” piloting of the drone, i.e. where the operator uses the image of the camera in the same way as if he were himself on board the drone. It may also serve to capture sequences of images of a scene towards which the drone is directed, the operator using the drone in the same way as a camera that, instead of being held in hand, would be borne by the drone. The images collected can be recorded, put online on web sites, sent to other Internet users, shared on social networks, etc.

The WO 2010/061099 A2, EP 2 364 757 A1 and EP 2 450 862 A1 (Parrot) describe the principle of piloting a drone through a touch-screen multimedia telephone or tablet having an integrated accelerometer, for example a smartphone of the iPhone type or a tablet of the iPad type (registered trademarks).

In the following of the description, the term “tablet” will generally be used to denote this apparatus, but this term must not be understood in its narrow meaning; on the contrary, it also includes the functionally equivalent devices, in particular all the portable devices provided with at least one visualization screen and with wireless data exchange means, such as smartphone, etc.

The tablet incorporates the various control elements required for the detection of the piloting commands and the bidirectional exchange of data via a radio link of the Wi-Fi (IEEE 802.11) or Bluetooth wireless local network type, established directly with the drone. Its touch screen displays the image captured by the front camera of the drone, with, in superimposition, a certain number of symbols allowing the control of the flight and the activation of commands by simple contact of the operator's finger on this touch screen.

The bidirectional wireless radio link comprises an uplink (from the tablet to the drone) and a downlink (from the drone to the tablet) to transmit data frames containing:
(from the tablet to the drone) the piloting commands, hereinafter simply denoted “commands”, sent at regular intervals and on a systematic basis,
(from the drone to the tablet) the video stream coming from the camera; and
(from the drone to the tablet) as needed, flight data established by the drone or state indicators such as: battery level, phase of flight (take-off, automatic stabilization, landed on the ground, etc.), altitude, detected fault, etc.

To allow such a communication, the drone comprises a communication means connected to an antenna so as to allow a communication with the piloting device.

The antenna is for example a Wi-Fi antenna.

The drone may also comprise a geolocation module.

When the drone is started, in order for it to be able to determine its location, it will receive ephemerides allowing it to calculate the position of the satellites, then to be able to determine its location.

To operate, the geolocation module needs to obtain the ephemeris of at least four satellites.

As regards the satellites of the GPS type, each satellite transmits a frame comprising five sub-frames of six seconds each, the first three sub-frames of which contain the ephemerides of the satellite. The ephemerides contain the detailed orbital parameters of the satellites.

The ephemeris data are regularly updated. For example, the ephemeris data change every two hours for the satellites of the GPS system and every 30 minutes for the satellites of the Glonass system.

The calculation of the position of the geolocation module and hence of the drone is performed from the digital data of the received ephemerides.

The ephemeris acquisition performance of the geolocation module at the power on thereof is determined in great part by the satellites in view.

Hence, the geolocation module may efficiently receive the ephemerides if the receipt is correct during the three messages of each satellite.

However, if the receipt is bad or discontinuous, in particular when there is an interruption during the receipt, then the geolocation module must again wait for 30 seconds in order to receive the new complete frame of the ephemeris data.

At the power on of a drone, the delay for obtaining ephemeris data may be relatively long, in particular in the eyes of a user. Moreover, given that the autonomy of the drone is relatively limited, the user is penalized by having to wait for the good receipt of the ephemeris data, in particular in case of bad loading, in which case the geolocation module of the drone must wait for the following frame to obtain again the ephemeris data. This waiting time is energy consuming and reduces accordingly the autonomy of the drone, which is not very acceptable for the user.

The object of the invention is to remedy for these various drawbacks, by proposing a method implemented in a drone piloting device, of loading satellite ephemeris data, and a method of loading satellite ephemeris data, implemented in a drone in order to reduce the delay of collection of the ephemerides and the loading thereof into the geolocation module of the drone and hence to reduce the consumption of the drone to perform this function of ephemeris data update in the geolocation module.

For that purpose, the invention proposes a method, implemented in a drone piloting device, of loading satellite ephemeris data, the drone comprising a geolocation module, the method comprising a step of establishing a communication between the piloting device and the drone according to a given communication mode.

Characteristically, the method further comprises the following steps implemented in the piloting device:
loading ephemeris data from a remote server connected to a communication network, and
sending the loaded ephemeris data to said drone.

According to various subsidiary characteristics:
the method further comprises a step of receiving information sent by the drone, relating to the drone identification, or information relating to the geolocation module, the step of sending the loaded ephemeris data to the drone is preceded by a step of adapting the loaded ephemeris data to the geolocation module of said drone;
the step of adapting the ephemeris data consists in modifying the format of the loaded ephemeris data and/or encapsulating the loaded ephemeris data into a format adapted to the geolocation module of the drone;
the method further comprises a step of memorizing the ephemeris data loaded in the piloting device;
the ephemeris data further comprises data of validity of the ephemeris data;
the method further comprises a step of verifying the validity of the memorized ephemeris data, if the ephemeris data is no longer valid, then the method executes again the step of loading the ephemeris data;
the method further comprises a step of verifying the validity of the memorized ephemeris data, if the memorized ephemeris data is valid, then the method sends the memorized ephemeris data to the drone.

The invention has also for object a method of loading satellite ephemeris data, implemented in a drone, for updating ephemeris data of a geolocation module, the drone being controlled by a piloting device, the method comprising a step of establishing a communication between the piloting device and the drone according to a given communication mode.

Characteristically, the method further comprises the steps of receiving satellite ephemeris data sent by the piloting device and loading the received ephemeris data into the geolocation module.

According to a particular embodiment of the invention, the method comprises a step of sending to the piloting device information relating to a geolocation module or information of identification of said drone.

According to another aspect of the invention, the method further comprises a step of memorizing the received ephemeris data in the drone.

An example of implementation of the invention will now be described, with reference to the appended drawings in which the same reference denote identical or functionally similar elements throughout the figures.

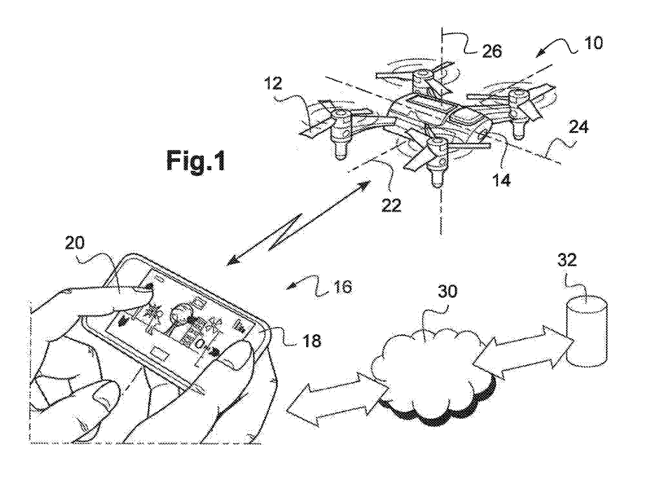

FIG. 1 is an overall view showing the drone and the associated remote-control apparatus allowing the remote piloting thereof.

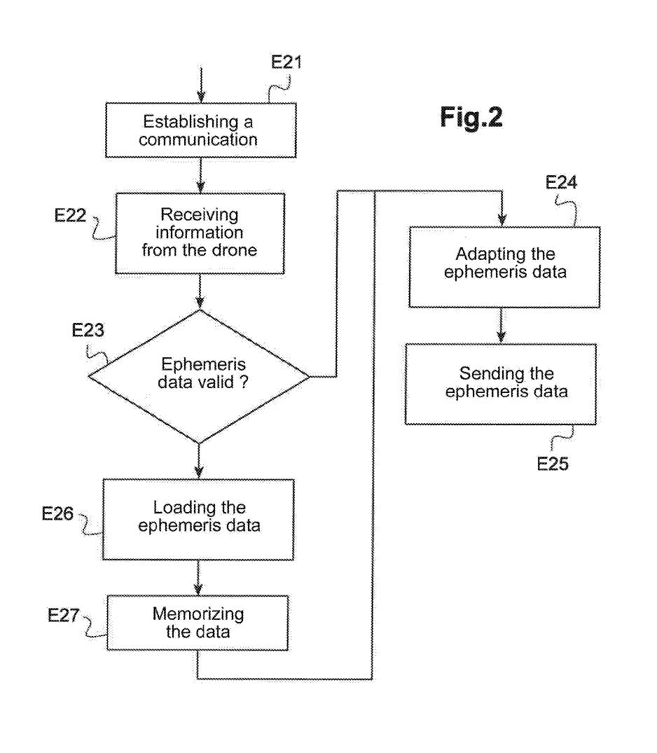

FIG. 2 illustrates a flow diagram of satellite ephemeris data loading according to the invention, implemented in a piloting device.

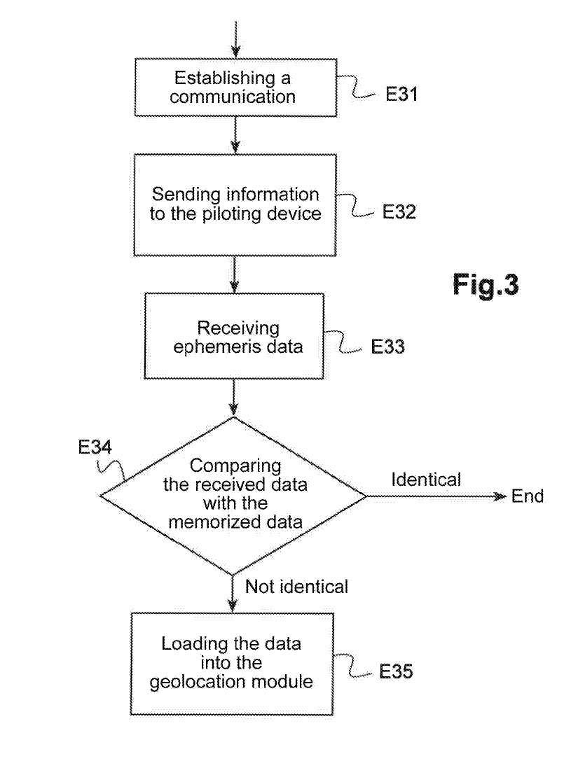

FIG. 3 illustrates a flow diagram of satellite ephemeris data loading according to the invention, implemented in a drone.

An exemplary embodiment of the invention will now be described.

In FIG. 1, the reference 10 generally denotes a drone, which is for example a quadricopter such as the Bebop Drone model of Parrot SA, Paris, France. This drone includes four coplanar rotors 12 whose motors are piloted independently from each other by an integrated system of navigation and control of attitude.

The invention also applies to a drone of the sailwing type, such as the eBee model of SenseFly SA, Swiss.

The drone is provided with a front-view camera 14 making it possible to obtain an image of the scene towards which the drone is directed. The drone also includes a vertical-view camera (not shown) pointing downward, adapted to capture successive images of the overflown land and used in particular to evaluate the speed of the drone with respect to the ground. Inertial sensors (accelerometers and gyrometers) allow measuring with a certain accuracy the angular speeds and the attitude angles of the drone, i.e. the Euler angles (pitch φ, roll θ and yaw ψ) describing the inclination of the drone with respect to a horizontal plane of a fixed terrestrial reference system. An ultrasound telemeter arranged under the drone moreover provides a measurement of the altitude with respect to the ground.

The drone also comprises a geolocation modules in order to be able, at each instant, to determine the position of the drone. This position is expressed in a format giving the latitude, the longitude and the altitude.

In particular, the geolocation module determines the position of the drone before the beginning of the flight and memorizes such information. Thereafter, during the flight, the drone is adapted to determine its position at each instant and in particular to emit this position information to the user.

Finally, the user may, in particular by sending a command, ask the drone to come back to the start position. From the memorized position of the drone before the beginning of the flight and its current position, the drone is adapted to come back to its origin position, i.e. the position before the beginning of the flight.

The drone 10 is piloted by a remote remote-control apparatus 16 provided with a touch screen 18 displaying the image captured by the front camera 14, with in superimposition a certain number of symbols allowing the activation of piloting commands by simple contact of a user's finger 20 on the touch screen 18. The apparatus 16 is provided with means for radio link with the drone, for example of the Wi-Fi (IEEE 802.11) local network type, for the bidirectional exchange of data from the drone 10 to the apparatus 16, in particular for the transmission of the image captured by the camera 14 and the flight parameters such as the altitude, the geolocation of the drone, etc., and from the apparatus 16 to the drone 10 for the sending of piloting commands.

The piloting of the drone consists in making it evolve by:
a) rotation about a pitch axis 22, to make it move forward or rearward;
b) rotation about a roll axis 24, to move it aside to the right or to the left;
c) rotation about a yaw axis 26, to make the main axis of the drone pivot to the right or to the left; and
d) translation downward or upward by changing the gas control, so as to reduce or increase, respectively, the altitude of the drone.

The piloting device is also provided with communication means adapted to be connected to a communication network 30, for example on the Internet network, using the 3G network, the 4G network, or by a WiFi connection, for example, in order to be connected to a server 32 connected to the communications network 30.

Hence, the piloting device is adapted, on the one hand, to communicate with the drone and, on the other hand, to communicate on a communication network to be connected to a remote server.

Remote servers, for example, provide to any user current ephemeris data, or even ephemeris data predicted over several days. In particular, the providers of geolocation modules propose such a service.

According to the invention, at the power on of the drone, and after the establishment of the communication between the drone 10 and the piloting device 16, the latter will load ephemeris data from data memorized into a remote server and send this loaded data to the drone 10.

That way, the piloting device 16 uses the communication network 30 of the Internet type to load the ephemeris data, then the device sends this data to the drone. The loading of data from a communication network of the Internet type being very efficient, the loading of the ephemeris data by the piloting device is made within a very short delay.

The drone hence obtains rapidly the ephemeris data allowing the drone to be in a ready-to-fly configuration within a short delay. The delay of obtaining this data by the drone is hence reduced, therefore limiting the consumption of energy of the drone. The loading of the ephemeris data according to the invention has hence a favourable impact on the drone autonomy.

According to a particular embodiment, the piloting device comprises a memory space so as to memorize the ephemeris data loaded from a server 32 connected to a communication network 30.

According to an alternative or complementary embodiment, the drone comprises a memory space so as to memorize the ephemeris data received from the piloting device.

According to a particular embodiment, the ephemeris data further comprise data of validity of the ephemeris data.

According to another embodiment, the data of validity of the ephemeris data is the date of loading of the ephemeris data or the date of the file containing the ephemeris data, the date of the file corresponding to the date of loading of the file.

FIGS. 2 and 3 illustrate flow diagrams allowing the loading of satellite ephemeris data, according to the invention, implemented, on the one hand, in a drone piloting device and, on the other hand, in the drone, to update ephemeris data in the geolocation data.

FIG. 2 illustrates the method, implemented in a piloting device 16 of a drone 10, of loading satellite ephemeris data.

The method begins by step E21, which is a step of establishing a communication between the piloting device 16 and the drone 10 according to a given communication mode. This step is in particular performed at the starting of the drone, in particular at the power on of the drone.

Step E21 is followed by a step E22 of receiving information relating to the drone, sent by the drone 10.

According to a first embodiment, such information is drone identification information allowing the piloting device to know the model of the drone.

Based on the model of the drone, the piloting device is adapted to determine the geolocation module equipping the drone.

According to a second embodiment, such information is information relating to the geolocation module equipping the drone, for example the model of the geolocation module.

Step E22 is then followed by a step E23 of verifying the validity of the ephemeris data previously memorized in the piloting device.

The verification of the validity of the ephemeris data is function of validity data attached to the ephemeris data, such data being for example a date.

According to a particular embodiment, the verification of the validity of the ephemeris data consists in comparing the current date, the date including for example the day, the month and the hour, with the memorized date of validity.

According to another embodiment, the ephemeris data is memorized in a file, the verification of the validity of the ephemeris data consists in comparing the current date with the date of the file corresponding to the date of the last loading of the ephemeris data.

If the number of days between the current date and the date of the file is lower than a determined number then the ephemeris data memorized in the file are considered as valid. In the contrary case, the ephemeris data is considered as invalid.

If the ephemeris data memorized in the piloting device is valid, then the method continues at step E24.

Step E24 is a step of adapting the ephemeris data that must be sent to the drone to then be loaded into the geolocation module of the drone.

In other words, during step E24, it is proceeded, if necessary, to a formatting of the ephemeris data to be sent according to a suitable format, understandable by the drone or by the geolocation module of the drone. This formatting may for example be a modification of the format of the data or an encapsulation of the data.

Step E24 is followed by a step E25 consisting in sending the ephemeris data to the drone.

According to a particular embodiment, the piloting device sends the file containing the ephemeris data to the drone.

At step E23, if the ephemeris data is no longer valid, then the method continues at step E26 consisting in loading ephemeris data from a remote server 32 connected to a communication network 30. Hence, the piloting device 10, via the communication network 30, in particular Internet, will load the ephemeris data from a remote server 32, using for example the 3G, or 4G or WiFi communication protocol.

After the loading of the data, the piloting device will memorize, during a step E27, the ephemeris data in a memory space of the piloting device 16. Step E27 is then followed by the previously described steps E24 and E25, in order to adapt the format of the ephemeris data if required, then to send the ephemeris data to the drone.

According to a particular embodiment, the method executes a loading of the ephemeris data into a remote server at each new establishment of a communication with the drone, i.e. at each power on of the drone. According to this embodiment, the piloting device does not memorize the loaded ephemeris data.

FIG. 3 illustrates the method of loading satellite ephemeris data, according to the invention, implemented in a drone, for updating ephemeris data of a geolocation module of said drone.

The method starts by a step E31 of establishing a communication between the piloting device and the drone according to a given communication mode.

Step E31 is followed by a step E32 of sending to the piloting device information relating to the drone.

According to a first embodiment, such information is drone identification information allowing the piloting device to know the model of the drone and to deduce therefrom the geolocation module equipping the drone.

According to a second embodiment, such information is information relating to the geolocation module equipping the drone, for example the model of the geolocation module.

Then, step E32 is followed by a step E33 of receiving satellite ephemeris data sent by the piloting device 16.

According to a particular embodiment, the drone receives a file containing the ephemeris data.

Step E33 is followed by a step E34 consisting in comparing the received ephemeris data with the data memorized in the drone, in particular by comparing the file of the ephemeris data with the file memorized in the drone, for example with a hashing method.

The hashing method allows calculating an imprint of each of the files in order to identify the two files respectively. If the imprints of the two files are identical, then the two files are identical. If, on the contrary, the imprints are different, then the two files are different.

If the comparison step E34 allows determining that the two files are identical, then the method is terminated, the ephemeris data received are not memorized in the drone. The ephemeris data memorized in the drone are loaded into the geolocation module.

If, on the contrary, at step E34, it is determined that the two files are different, then step E34 is followed by a step E35 of memorizing the received ephemeris data in the drone and loading the received ephemeris data, in particular the received file, into the geolocation module.

The communication protocol implemented between the piloting device and the drone for sending and receiving the ephemeris data may be a synchronous communication mode, i.e. for example, a communication mode based on a client-server scheme, or an asynchronous communication mode, i.e. a communication mode based on a message sending.

1. A method, implemented in a drone piloting device (16), of loading satellite ephemeris data, the drone (10) comprising a geolocation module, the method comprising a step of establishing a communication between the piloting device (16) and the drone (10) according to a given communication mode,
characterized in that the method further comprises the following steps implemented in the piloting device:
loading ephemeris data (E26) from a remote server (32) connected to a communication network (30), and
sending the loaded ephemeris data (E25) to said drone.

2. The method of loading satellite ephemeris data according to claim 1, characterized in that the method further comprises a step of receiving information sent by the drone, relating to the drone identification, or information relating to the geolocation module, the step of sending the loaded ephemeris data to the drone being preceded by a step of adapting the loaded ephemeris data to the geolocation module of said drone.

3. The method of loading satellite ephemeris data according to claim 2, characterized in that the step of adapting the ephemeris data consists in modifying the format of the loaded ephemeris data and/or encapsulating the loaded ephemeris data into a format adapted to the geolocation module of the drone.

4. The method of loading satellite ephemeris data according to claim 1, characterized in that the method further comprises a step of memorizing the ephemeris data loaded in the piloting device.

5. The method of loading satellite ephemeris data according to claim 1, characterized in that the ephemeris data further comprises data of validity of the ephemeris data.

6. The method of loading satellite ephemeris data according to claims 4, characterized in that the method further comprises a step of verifying the validity of the memorized ephemeris data, if the ephemeris data is no longer valid, then the method executes again the step of loading the ephemeris data.

7. The method of loading satellite ephemeris data according to claims 4, characterized in that the method further comprises a step of verifying the validity of the memorized ephemeris data, if the memorized ephemeris data is valid, then the method sends the memorized ephemeris data to the drone.

8. A method of loading satellite ephemeris data, implemented in a drone (10), for updating ephemeris data of a geolocation module, the drone being controlled by a piloting device (16), the method comprising a step of establishing a communication between the piloting device and the drone according to a given communication mode, characterized in that the method further comprises the steps of receiving satellite ephemeris data (E33) sent by the piloting device and loading the received ephemeris data into the geolocation module.

9. The method of loading satellite ephemeris data according to claim 8, characterized in that the method comprises a step of sending to the piloting device information relating to a geolocation module or information of identification of said drone.

10. The method of loading satellite ephemeris data according to claim 8, characterized in that the method comprises a step of memorizing the received ephemeris data in the drone.

11. The method of loading satellite ephemeris data according to claim 5, characterized in that the method further comprises a step of verifying the validity of the memorized ephemeris data, if the ephemeris data is no longer valid, then the method executes again the step of loading the ephemeris data.

12. The method of loading satellite ephemeris data according to claim 5, characterized in that the method further comprises a step of verifying the validity of the memorized ephemeris data, if the memorized ephemeris data is valid, then the method sends the memorized ephemeris data to the drone.

13. The method of loading satellite ephemeris data according to claim 6, characterized in that the method further comprises a step of verifying the validity of the memorized ephemeris data, if the memorized ephemeris data is valid, then the method sends the memorized ephemeris data to the drone.

14. The method of loading satellite ephemeris data according to claim 9, characterized in that the method comprises a step of memorizing the received ephemeris data in the drone.
